(19) United States
(12) Patent Application Publication
(10) Pub. No.: US 2009/0259849 A1
(43) Pub. Date: Oct. 15, 2009

(54) Methods and Apparatus for Authenticated User-Access to Kerberos-Enabled Applications Based on an Authentication and Key Agreement (AKA) Mechanism

(76) Inventors: Igor Faynberg, East Brunswick, NJ (US); Huilan Lu, Marlboro, NJ (US)

Correspondence Address: Ryan, Mason & Lewis, LLP, Suite 205, 1300 Post Road, Fairfield, CT, 06824, US

(21) Appl. No.: 12/100,777

(22) Filed: Apr. 10, 2008

(51) Int. Cl. H04L 9/00

(52) U.S. Cl. 713/169

(57) ABSTRACT

Methods and apparatus are provided for authenticated user-access to Kerberos-enabled applications based on an Authentication and Key Agreement mechanism. A user is first authenticated using an Authentication and Key Agreement mechanism based on a bootstrapping protocol that mutually authenticates the user and one or more servers; and, once the user is authenticated, the user is enabled to derive a session key and is provided with a first ticket to a Ticket Granting Server. The first ticket can establish an identity of the user and include the session key. The bootstrapping protocol can be based on a Generic Bootstrapping Architecture

### FIELD OF THE INVENTION

The present invention relates to user authentication techniques and, more particularly, to methods and apparatus for authenticated user-access to Kerberos-enabled applications.

### BACKGROUND OF THE INVENTION

Kerberos is an authentication protocol that allows entities communicating over a non-secure network to prove their identity to one another in a secure manner Kerberos is aimed primarily at a client-server model, and provides mutual authentication. Thus, the identity of both the user and the server are verified. See, for example, B Clifford Neuman and Theodore Ts'o, “Kerberos: An Authentication Service for Computer Networks,” IEEE Communications, 32(9), 33-38 (Sept. 1994); or John T. Kohl et al, “The Evolution of the Kerberos Authentication System” Distributed Open Systems, 78-94 (IEEE Computer Society Press, 1994), or C. Neuman et al, “RFC 4120: The Kerberos Network Authentication Service (V5),” (2005), each incorporated by reference herein

Kerberos is often used as an authentication mechanism in enterprise environments and is being deployed in provider networks in support of new services such as IPTV and network gaming. Kerberos builds on symmetric key cryptography and typically requires a trusted third party, referred to as a Key Distribution Center (KDC) The Key Distribution Center typically comprises two logically separate parts: an Authentication Server (AuS) and a Ticket Granting Server (TGS) Kerberos works on the basis of “tickets” that serve to prove the identity of users The Key Distribution Center maintains a database of secret keys Each entity on the network (e.g, clients and servers) has a secret key that is known only to itself and to the Key Distribution Center Knowledge of this key is used to establish the identity of an entity. For communication between two entities, the Key Distribution Center generates a session key that can be used to secure interactions between the entities

The Authentication and Key Agreement (AKA) mechanism is a security protocol currently used in 3G telephony networks AKA is a challenge-response based authentication mechanism that uses a shared secret and symmetric cryptography AKA results in the establishment of a security association (i.e, a set of security data) between the user equipment and the network that enables a set of security services to be provided to the user.

As telecommunication and Information Technology (IT) services continue to converge, a need exists for authenticated user-access to Kerberos-enabled applications based on the AKA authentication mechanism A further need exists for authenticated user-access to Kerberos-enabled applications based on the possession of a particular device, such as a cellular telephone, to provide an enhanced user experience

### SUMMARY OF THE INVENTION

Generally, methods and apparatus are provided for authenticated user-access to Kerberos-enabled applications based on an Authentication and Key Agreement mechanism According to one aspect of the invention, a method is provided for authenticating a user to one or more Kerberos-enabled applications. A user is first authenticated using an Authentication and Key Agreement mechanism based on a bootstrapping protocol that mutually authenticates the user and one or more servers Once the user is authenticated, the user is enabled to derive a session key and is provided with a first ticket to a Ticket Granting Server The first ticket can establish an identity of the user and include the session key.

According to another aspect of the invention, the bootstrapping protocol can be based on a Generic Bootstrapping Architecture. The session key can be used to encrypt one or more data elements sent by the user, and may have a lifetime indicator to prevent replay attacks The session key can be generated, for example, by a Key Derivation Function. The user can authenticate to the Ticket Granting Server using the first ticket and then request a ticket to one or more desired Application Servers. The first ticket can optionally be provided to the user as part of an XML document.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a conventional Generic Bootstrapping Architecture;

FIG. 2 illustrates a conventional procedure for authenticating a user to a Kerberos-enabled application; and

FIG. 3 illustrates an authentication procedure incorporating features of the present invention for access to a Kerberos-enabled application using AKA authentication.

### DETAILED DESCRIPTION

The present invention provides authenticated user-access to Kerberos-enabled applications based on the AKA authentication mechanism. According to one aspect of the invention, the initial user authentication procedure in a Kerberos environment is modified to include portions of an AKA authentication mechanism. In one exemplary embodiment, the Kerberos user authentication procedure is modified to include portions of the AKA procedure from the Generic Bootstrapping Architecture (GBA) of 3GPP networks, discussed below. The AKA procedure will result in, among other things, a temporary user identifier, a session key, and a ticket to a known Ticket Granting Server. With these objects, the user can then proceed through the normal Kerberos procedure to request a ticket to a known Application Server (AS) and ultimately be authenticated to the application server by presenting the ticket

### Generic Bootstrapping Architecture

Generally, the Generic Bootstrapping Architecture provides application-independent functions for mutual authentication of user equipment and servers previously unknown to each other and for thereafter “bootstrapping” the exchange of security elements, such as secret session keys The Generic Bootstrapping Architecture can be employed to authenticate a user, for example, to network services that require authentication, such as mobile television services. See, for example, 3GPP Standards, GBA (Generic Bootstrapping Architecture), and 3GPP TS 33.919, 33.220 24 109, 29.109, each incorporated by reference herein

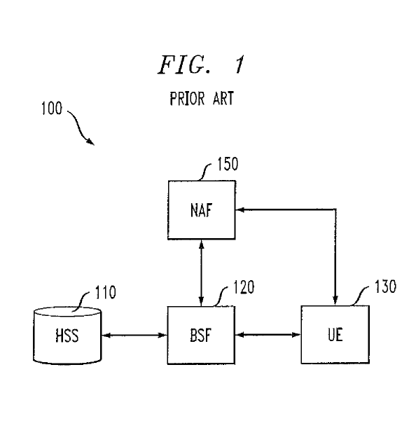

FIG. 1 is a schematic block diagram of a conventional Generic Bootstrapping Architecture 100. As shown in FIG. 1, the Generic Bootstrapping Architecture 100 typically comprises user equipment (UE) 130 attempting to access a Network Application Function 150 over a mobile network The user equipment 130 may be embodied, for example, as a mobile cellular telephone that is attempting to access a specific service, such as mobile TV, provided by the Network Application Function 150. In accordance with the Generic Bootstrapping Architecture 100, a Bootstrapping Server Function (BSF) 120 establishes a security relation between the user equipment 130 and the Network Application Function 150. As discussed hereinafter, a Home Subscriber Server (HSS) 110 provided by the network service provider stores user profiles.

When the user equipment 130 attempts to access a service provided by the Network Application Function 150, the Network Application Function 150 refers the user equipment 130 to the Bootstrapping Server Function 120. The user equipment 130 and the BSF 120 mutually authenticate using the 3GPP AKA procedure In addition, the BSF 120 sends related queries to the HSS 110. Thereafter, the user equipment 130 and BSF 120 agree on a session key to be used by the user equipment 130 to authenticate itself to the application server (NAF 150).

### Kerberos Authentication

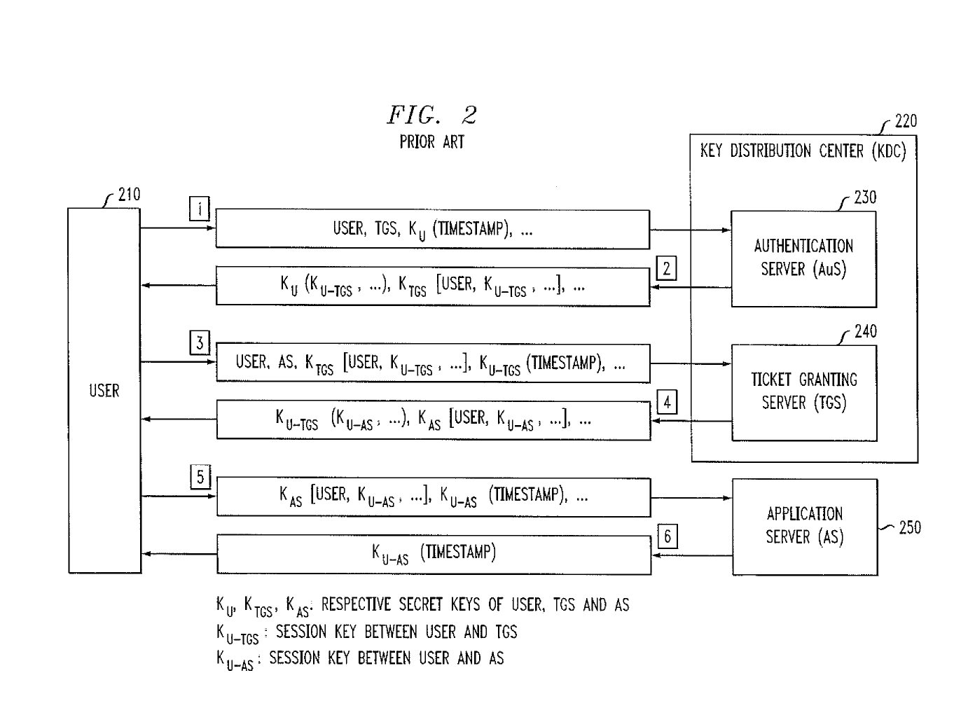

As previously indicated, Kerberos typically requires a trusted third party, referred to herein as a Key Distribution Center 220. The Key Distribution Center 220 typically comprises an Authentication Server 230 and a Ticket Granting Server 240. FIG. 2 illustrates a conventional procedure for authenticating a user based on a shared secret between the user 210 and the Authentication Server 230 for access to a Kerberos-enabled application, provided by an Application Server 250

As shown in FIG. 2, during step 1, the user 210 identifies itself, presents the quantity K_{U}(timestamp) as a proof of authenticity, and requests a ticket to the TGS 240. The quantity K_{U}(timestamp) is a timestamp encrypted with K_{U}. Thereafter, during step 2, upon successful authentication of the user 210, the AuS 230 sends back the session key, K_{U-TGS}, for use between the user and TGS 240, and a ticket part of which is encrypted as embodied in K_{TGS}(User, K_{U-TGS} . . . ). As shown in FIG. 2, the key is encrypted with K_{U} and the ticket with K_{TGS}, which authenticates the AuS 230.

During step 3, the user identifies itself to the TGS 240, presents the quantity K_{U-TGS}(timestamp) as a proof of authenticity, presents the TGS ticket, part of which is encrypted and shown as K_{TGS}(User, K_{U-TGS}, . . . ), and requests a ticket to the Application Server 250 During step 4, the TGS 240, upon successful authentication of the user 210, sends back the session key, K_{U-AS}, for use between the user 210 and AS 250, and the AS ticket, part of which is encrypted and shown as K_{AS}(User, K_{U-AS}, . . . ).

During step 5, the user 210 identifies itself to the AS 250, presents the quantity K_{U-AS}(timestamp) as a proof of authenticity and presents the AS ticket, part of which is encrypted and shown as K_{AS}(User, K_{U-AS}).

During step 6, the AS 250, upon successful authentication of the user 210 based on the quantity K_{U-AS}(timestamp), optionally authenticates itself to the user 210

### Kerberos Authentication Based on AKA

As previously indicated, the present invention provides authenticated user-access to Kerberos-enabled applications based on the AKA authentication mechanism. The initial user authentication procedure in Kerberos is modified to include portions of an AKA authentication mechanism. In one exemplary embodiment, the Kerberos user authentication procedure is modified to include portions of the AKA procedure from the Generic Bootstrapping Architecture 100 of FIG. 1 The disclosed AKA procedure will result in, among other things, a temporary user identifier, session key, and ticket to the Ticket Granting Server 240 With these objects, the user 210 can proceed through the normal Kerberos procedure, as discussed above in conjunction with FIG. 2, to request a ticket to the Application Server 250 and ultimately be authenticated to the Application Server 250 by presenting the ticket.

The exemplary embodiment of the present invention replaces steps 1 and 2 from the Kerberos authentication procedure discussed above in conjunction with FIG. 2, with the AKA-related procedure in the GBA 100. In addition, the AuS 230 is subsumed by the Bootstrapping Server Function 120 defined in the GBA 100. As such, the Bootstrapping Server Function 120 is augmented to allow the generation of the ticket and inclusion of the ticket in the response to the UE 130.

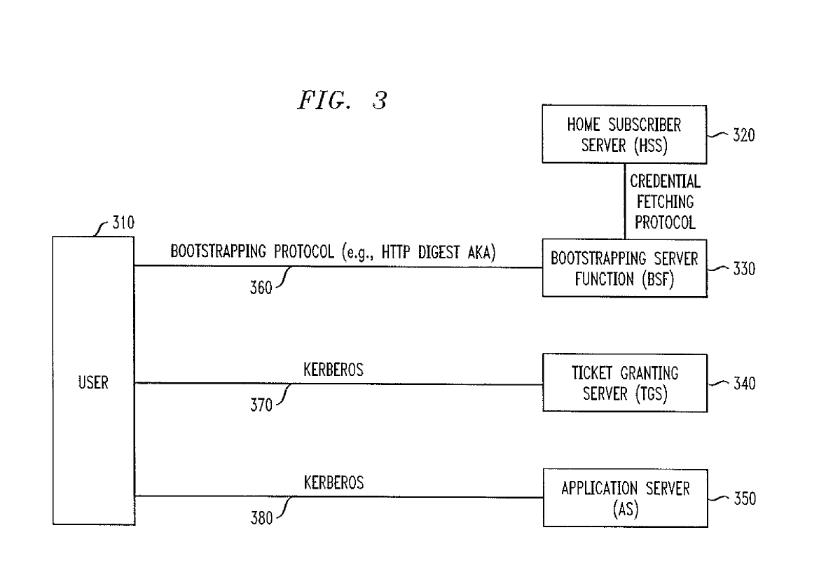

FIG. 3 illustrates an authentication procedure incorporating features of the present invention for access to a Kerberos-enabled application using AKA authentication As shown in FIG. 3, Ticket Granting Server (TGS) 340 and Application Server (AS) 350 may be embodied in a similar manner to the corresponding elements of FIG. 2. In addition, the interactions between the user 310 and the Ticket Granting Server 340 during step 370 and the interactions between the user 310 and the Application Server 350 during step 380 may be performed in accordance with the Kerberos procedure, as discussed above in conjunction with FIG. 2.

Generally, the interactions between the user 310, the Home Subscriber Server 320 and the Bootstrapping Server Function 330 during step 360 may be performed in accordance with the GBA procedure, as discussed above in conjunction with FIG. 1 As discussed hereinafter, the interactions between the user 310 and BSF 330 during step 360 allow the authentication of the user 310 based on AKA in accordance with the present invention and then the eventual derivation of a number of security elements, such as secret session keys As shown in FIG. 3, the exemplary interactions between the user 310 and BSF 330 during step 360 may be implemented in accordance with a Bootstrapping Protocol (e g., HTTP digest AKA), as discussed above in conjunction with FIG. 1

The exemplary security elements derived during step 360 include:

a temporary user identifier (B-TID), that can be used as the user identifier (i e., User) in the ensuing Kerberos interactions, if anonymity is desired;

a key lifetime to prevent replay attacks;

a master session key, K_{S}, based on which, possibly together with the User identity, TGS identity and other parameters, a Key Derivation Function (KDF) can derive the session key, K_{U-TGS}, between the user 310 and TGS 340; and

a ticket to the TGS 340, for example, in the form specified in IETF RFC 4120

The Key Derivation function can be based, for example, on the description in Annex B (normative) of 3GPP Technical Specification TS 33.220, incorporated by reference herein.

It is noted that the key lifetime, temporary user identifier and ticket can be carried in an XML document as part of the response from the BSF 330 to the user 310 during step 360. After response 360, the normal Kerberos procedure follows.

### CONCLUSION

While FIG. 3 shows an exemplary sequence of steps, it is also an embodiment of the present invention that the sequence may be varied Various permutations of the algorithm are contemplated as alternate embodiments of the invention

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit

Thus, the functions of the present invention can be embodied in the form of methods and apparatuses for practicing those methods One or mote aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

### System and Article of Manufacture Details

As is known in the art, the methods and apparatus discussed herein may be distributed as an article of manufacture that itself comprises a computer readable medium having computer readable code means embodied thereon The computer readable program code means is operable, in conjunction with a computer system, to carry out all or some of the steps to perform the methods or create the apparatuses discussed herein The computer readable medium may be a recordable medium (e g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, ox other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk

The computer systems and servers described herein each contain a memory that will configure associated processors to implement the methods, steps, and functions disclosed herein The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention

We claim:

1. A method for authenticating a user to one or more Kerberos-enabled applications, comprising:
authenticating said user using an Authentication and Key Agreement mechanism based on a bootstrapping protocol that mutually authenticates said user and one or more servers; and
upon authenticating said user, enabling said user to derive a session key and providing said user with a first ticket to a Ticket Granting Server, wherein said Ticket Granting Server provides a ticket to one or more Application Servers that provide one or more Kerberos-enabled applications.

2. The method of claim 1, wherein said first ticket establishes an identity of said user.

3. The method of claim 1, wherein said first ticket includes said session key.

4. The method of claim 1, wherein said bootstrapping protocol is based on a Generic Bootstrapping Architecture

5. The method of claim 1, wherein said session key is used to encrypt one or more data elements sent by said user

6. The method of claim 1, wherein said session key has a lifetime indicator to prevent replay attacks

7. The method of claim 1, wherein said session key is generated by a Key Derivation Function.

8. The method of claim 1, wherein said user authenticates to said Ticket Granting Server using said first ticket and requests said ticket to one or more desired Application Servers

9. The method of claim 1, further comprising the step of providing said user with a temporary user identifier.

10. The method of claim 1, wherein said first ticket is provided to said user as part of an XML document

11. An apparatus for authenticating a user to one or more Kerberos-enabled applications, the apparatus comprising:
a memory; and
at least one processor, coupled to the memory, operative to:
authenticate said user using an Authentication and Key Agreement mechanism based on a bootstrapping protocol that mutually authenticates said user and one or more servers; and
upon said authentication of said user, enable said user to derive a session key and provide said user with a first ticket to a Ticket Granting Server, wherein said Ticket Granting Server provides a ticket to one or more Application Servers that provide one or more Kerberos-enabled applications

12. The apparatus of claim 11, wherein said first ticket establishes an identity of said user

13. The apparatus of claim 11, wherein said first ticket includes said session key.

14. The apparatus of claim 11, wherein said bootstrapping protocol is based on a Generic Bootstrapping Architecture.

15. The apparatus of claim 11, wherein said session key is used to encrypt one or more data elements sent by said user

16. The apparatus of claim 11, wherein said session key has a lifetime indicator to prevent replay attacks.

17. The apparatus of claim 11, wherein said session key is generated by a Key Derivation Function

18. The apparatus of claim 11, wherein said user authenticates to said Ticket Granting Server using said first ticket and requests said ticket to one of more desired Application Servers

19. The apparatus of claim 11, wherein said first ticket is provided to said user as part of an XML document.

20. An article of manufacture for authenticating a user to one or more Kerberos-enabled applications, comprising a machine readable storage medium containing one or more programs which when executed implement the steps of:
authenticating said user using an Authentication and Key Agreement mechanism based on a bootstrapping protocol that mutually authenticates said user and one or more servers; and
upon authenticating said user, enabling said user to derive a session key and providing said user with a first ticket to a Ticket Granting Server, wherein said Ticket Granting Server provides a ticket to one or more Application Servers that provide one or more Kerberos-enabled applications.
